(19) United States
(12) Patent Application Publication
(10) Pub. No.: US 2010/0303927 A1
(43) Pub. Date: Dec. 2, 2010

(54) Composition and method for incorporating colorant into wood

(76) Inventor: Michael P Pompeo, Sumter, SC (US)

Correspondence Address: Christopher G. Hayden;Hayden Stone PLLC,, Suite 409, 101 N. Columbus St., Alexandria, VA, 22314, US

(21) Appl. No.: 12/453,922

(22) Filed: May 27, 2009

(51) Int. Cl. A01N 59/20; D06P 3/60

(52) U.S. Cl. 424/631; 8/402

(57) ABSTRACT

A method for imparting brown and natural colorants to wood treated with micronized wood treatments, by injecting into the wood a a salt of lignosulfonate and a salt of humic acid or derivatives thereof in a total amount that is greater that 0.02 pounds total per cubic foot of wood, the quantity of salts of lignosulfonates and salts of humic acids or derivatives thereof being sufficient to impart a brown or dark color to the treated wood.

### FIELD OF THE INVENTION

The present invention is directed to imparting brown and natural colorants to wood treated with “micronized copper” wood treatments, that is, wood containing a biocidally effective quantity of injected particles that comprise crystalline sparingly soluble copper salts such as copper borate, copper hydroxide, tribasic copper sulfate, basic copper carbonate, or mixture thereof, and a quantity of the acid form and/or salts of lignosulfonate, the acid form and/or salts of humic acid, or most preferably both, the quantity being sufficient to impart a pleasing brown to dark color to the treated wood.

### BACKGROUND OF THE INVENTION

We have previously disclosed and submitted for patent the concept of preparing and directly injecting sub-micron sized biocide particles into wood. This process involved the wet-milling of biocides to prepare aqueous suspension concentrates of sub-micron particles which are then diluted with water and/or other co-biocides prior to the pressure treatment process (US Patent Application 20040258768 and subsequent filings).

In many instances, end users want distinctive coloring which is indicative of treated (that is, preserved) wood. PhibroWood's micronized wood preservative Sustain 20T® (micronized basic copper carbonate and tebuconazole) provides a beautiful, natural appearance with adequate color which when present at amounts ranging from about 0.05 pounds (as copper) per cubic foot to about 0.3 pounds (as copper) per cubic foot allows the common observer to easily identify the treated product from untreated wood.

However, in certain markets it may be advantageous to provide a colorant to yield additional color value to wood treated with a micronized copper salt wood preservative system such as Sustain 20T®.

Pigments and dyes are well known and used in the wood industry. Pigments are solid products that when wet-milled and are applied with traditional wood treatment methods have advantages similar to sub-micron particulate injection. However, relatively high concentrations of pigments are required in order to achieve significant color value. Pigments are also subject to uniformity issues when used at low dose (cost efficient) levels.

Dyes are generally soluble in water and provide significant color value to treated wood at low concentrations, however, they are sensitive to UV light and do not weather well and therefore do not provide long term color fastness.

U.S. Pat. No. 3,281,458 teaches the preparation of dioctadecyldimethylammonium humate, ditallowdimethylammonium humate, dipentadecyldimethylammonium humate, and didodecyldimethylammonium humate by reacting humic acid, lignite, aqueous sodium hydroxide and a chloride quat, where this material can be used as a paper dye. U.S. Pat. No. 6,172,117 teaches a wood preservative having quaternary ammonium compounds which have a fatty aliphatic substituents such as cocoalkyl substituents on the quaternary nitrogen atom, where the preservative can have copper atoms bound thereto and where humic acid can be used to fix the preservative. Japanese Patent Application Kokai No. S61-268729 discloses a method for impregnating wood including the first step of adding a lignin derivative to wood and the second step of impregnating the wood with a weak acidic aqueous solution containing metal ions for making lignin water-insoluble in order to prevent the attack by microorganisms. Published application 20030017565 teaches injecting lignin-compounds into wood and that the compounds can have a preservative effect.

### SUMMARY OF THE INVENTION

The invention includes a method of coloring micronized-copper-preserved wood using traditional vacuum/pressure wood treating methods where water-soluble products including salts of lignosulfonate and salts of humic acid are used to color wood. The addition of water repellant/stabilizer may be used to provide additional life expectancy of the colorant systems.

The invention further includes a method of formulating micronized-copper wood preservatives with colorant compositions that can be directly injected into various species of wood. The invention includes a method of adding colorant compositions to previously formulated and micronized wood preservatives and directly injecting the mixture into various species of wood. The invention includes coloring wood that had previously been treated with micronized-copper wood preservatives. The invention includes a method of pressure treating various species of wood with said colorant/wood preservative compositions. The invention includes a composition of colorants that will provide better color value to treated wood at relatively low rates as compared to traditional pigments used in the art. Finally, the invention includes composition of colorants that will provide better water fastness and longevity to UV exposure as compared to traditional dyes used in the art.

### DESCRIPTION OF THE PREFERRED EMBODIMENTS

The invention includes formulation of micronized-copper-type wood preservatives—stable suspensions of sub-micron sized biocidal copper salt- or copper oxide-containing particles —with the addition of colorants including salts of lignosulfonate and surfactants. The invention may optionally but advantageously further include humic acid. The invention may optionally but advantageously further include water repellants/stabilizers.

Alternatively, the invention includes formulation of micronized-copper-type wood preservatives—stable suspensions of sub-micron sized biocidal copper salt- or copper oxide-containing particles—with the addition of colorants including salts of humic acid and surfactants. The invention may optionally but advantageously further include lignosulfonate. The invention may optionally but advantageously further include water repellants/stabilizers.

The wood-injectable sparingly soluble copper salt/copper oxides particles generally have a particle size distribution such that less than 4%, preferably less than 3%, more preferably less than 2% by weight of the particles have a diameter (measured by for example settling velocity) of greater than 1 micron. More advantageously the wood-injectable sparingly soluble copper salt/copper oxides particles generally have a particle size distribution such that less than 4%, preferably less than 3%, more preferably less than 2% by weight of the particles have a diameter (measured by for example settling velocity) of greater than 0.7 micron. The most useful particle size distributions are centered about 0.14 microns to about 0.35 microns. A preferred slurry comprises particles comprising a sparingly soluble copper salt, copper hydroxide, or both, wherein the weight average diameter d₅₀ of the particles in the slurry is between 0.1 microns and 0.7 microns and the d₉₈ of the particles in the slurry is less than about 1 micron (that is, less than 2% by weight of the particles have a diameter of 1 micron or greater).

Particle size as used herein is the mean weight average particle diameter, which is equivalent to the mean volume average particle diameter, also known as d.sub.50. For larger particles this “average” value can be determined from settling velocity in a fluid, which is a preferred method of measuring particle size. Unless otherwise specified, as used herein the biocide particle diameter is given as the d₅₀ weight mean average diameter. The dₓₓ is the diameter where the subscript “xx” is the percent of the weight of the solid material that has an average diameter smaller than the stated diameter. Other key parameters, such as d₈₀, d₉₅, and d₉₉, are similarly defined and are useful for various applications where not only is the weight mean particle diameter important but also the amount of larger particles (the size distribution, especially in the higher particle diameter range). Particle diameter can be beneficially determined by Stokes Law settling velocities of particles in a fluid, for example with a CAPA™ 700 sold by Horiba and Co. Ltd., or a Sedigraph™ 5100T manufactured by Micromeritics, Inc., which uses x-ray detection and bases calculations of size on Stoke's Law, to a size down to about 0.2 microns. Smaller sizes are beneficially determined by for example a dynamic light scattering method, preferably with a Coulter™ counter, or with a laser scattering method, or electron microscopy.

The preferred particles contain crystalline sparingly soluble copper salt/copper oxides such as copper hydroxide, basic copper carbonate, tribasic copper sulfate, copper oxychloride, copper borate, basic copper borate, copper(I) oxide, copper(II) oxide, or combinations thereof. The most preferred particles contain crystalline sparingly soluble copper hydroxide, basic copper carbonate, or combinations thereof. If copper hydroxide particles are used, then advantageously the crystalline hydroxide material is stabilized against dehydration into copper oxides.

While the invention is described in the preferred embodiment where the colorants are matched with micronized-copper-type wood preservatives, the colorant invention (lignosulfonates and salts of humic acids) is useful for all micronized biocidal treatments, including without limitation injectable slurries of organic biocides and injectable slurries of fire retardants, for example zinc borate.

The micronized wood preservative is added to wood to provide between 0.05 to over 0.3 pounds (as Cu) of sparingly soluble copper salts per cubic foot of wood. This material (be it copper or be it another micronized wood treatment material) is injected into the wood in a slurry. Advantageously the colorants of one embodiment of this invention—lignosulfonates in an amount greater that 0.02, preferably greater than 0.04, more preferably greater than 0.08, for example at least 0.1 pound per cubic foot of wood, salts of humic acids in an amount greater that 0.005, preferably greater than 0.01, more preferably greater than 0.03, for example at least 0.05 pound per cubic foot of wood, or most preferably both lignosulfonates and salts of humic acids in a total amount that is greater that 0.02, preferably greater than 0.04, more preferably greater than 0.08, for example at least 0.1 pound per cubic foot of wood.

Advantageously in the embodiment where the colorants are used with micronized copper wood treatments the salts of lignosulfonate are added in an about to provide between 0.1 and 1 parts by weight, preferably between about between 0.3 and 0.6 parts by weight, of one or more salts of lignosulfonate, e.g., sodium lignosulfonate, per one part of copper. Alternatively, the amount of lignosulfonate in the slurry injected into wood is adjusted to provide between 0.01 and 0.4 pounds, for example between 0.02 and 0.2 pounds, of lignosulfonate per cubic foot of treated wood.

Advantageously in the embodiment where the colorants are used with micronized copper wood treatments the salts of humic acids are added in an about to provide between 0.05 and 1 parts by weight, preferably between about between 0.1 and 0.3 parts by weight, of one or more salts of humic acid per one part of copper. Alternatively, the amount of salts of humic acid in the slurry injected into wood is adjusted to provide between 0.005 to 0.3 pounds, for example between 0.01 and 0.2 pounds, of salts of humic acid per cubic foot of treated wood.

Lignosulfonates, or sulfonated lignin, (CAS number 8062-15-5) are water-soluble anionic polyelectrolyte polymers. Sodium lignosulfonate is a known dispersant. About 25-50 thousand tons of lignin dispersants are used each year by the textile dye industry. In this invention, however, the lignosulfonate itself has a dying function. Higher levels of sodium lignosulfonate (over and above the normal dispersant level) are added for color value with or without salts of humic acid.

Humic substances make up a large portion of the dark matter in humus. Humic substances have been designated as either humic acid, fulvic acid or humin. These fractions are defined strictly on their solubility in either acid or alkali, describing the materials by operation only, thus imparting no chemical information about the extracted materials.

Humic acids are typically defined as the fraction of humic substances that is not soluble in water under acidic conditions (pH<2) but is soluble at higher pH values. Humic acids are the major extractable component of soil humic substances. They are dark brown to black in color. Humic acids are thought to be complex aromatic macromolecules with amino acids, amino sugars, peptides, aliphatic compounds involved in linkages between the aromatic groups. Electron microscope observations revealed the humic acids of different soils to have polymeric structure, appearing in form of rings, chains, and clusters. The sizes of their macromolecules can range from 60-500 Angstroms.

Properties of humic acids and of closely related fulvic acids and lignin are as follows:

| Substances % dry ash-free basis: | C | H | O | N |
|---|---|---|---|---|
| Fulvic acids | 44-49 | 3.5-5.0 | 44-49 | 2.0-4.0 |
| Humic acids | 52-62 | 3.0-5.5 | 30-33 | 3.5-5.0 |
| Lignin | 62-69 | 5.0-6.5 | 26-33- | — |

The phrase “Humic acids” can include normal derivatives such as nitrohumic acid. Sodium salts of humic acid are useful. Particularly useful are potassium humate (available commercially as BorreGro HA-2™ and a potassium humate product BorreGro HA-1™ where the humic acid component is sulphonated to yield a humate product that is soluble over a wide pH range.

Alternatively, some or all of the humic acid in the colorant product can be replaced by fulvic acids to provide a lighter or yellower color. Fulvic acids are generally lower weight (e.g., 2000 to 10000) compared to humic acids which can have a mole weight of up to 300000. The total acidities of fulvic acids (900-1400 meq/100 g) are considerably higher than for humic acids (400-870 meq/100 g). Another important difference is that while the oxygen in fulvic acids can be accounted for largely in known functional groups (COOH, OH, C═O), a high portion of the oxygen in humic acids seems to occur as a structural component of the nucleus.

The injectable slurry can optionally also include a fixative to facilitate the binding of the biocide to the treated material such as wood. Such fixative agents include starch, carboxymethyl cellulose, gum arabic, polyvinyl alcohol, colophony esters, glycerophthalic resins, and various other resins.

The wood preservative composition can also include a water repellant. Suitable water repellants/stabilizers include either water soluble or emulsifiable versions of the following: silicones, fatty acid salts (such as, for example, calcium, magnesium or aluminum stearate), polyurethanes, alkyl biphenyls, fatty alcohols, hydrocarbon waxes, phosphated glycerides, PVP copolymers, and ethylene and propylene homopolymers.

While the preservatives described above exhibit biocidal properties with respect to microorganisms such as molds and fungus, other biocides can also be included in the preservative composition. Suitable insecticides for use in wood preservatives are those having a biocidal effect on xylophagous insects such as, for example, termites, wood eating ants, Capricorn beetles, deathwatch beetles, powder post beetles, and like insects. Exemplary insecticides include chlorothalonil, methoxychlor(2,2′-bis(4-methoxyphenyl)-1,1,1-trichloroethane), lindane (gamma isomer of hexachloro-cyclohexane), chlordane(octachlorohexahydromethanoindene), aldrin(endo hexachlorohexahydrodimethanonaphthalene), toxaphene, ethion(O,O,O′,O′-tetraethyl-S,S′-methylenedithiophoshate), parathion(O,O-diethyl-O-paranitrophenyl thiophosphate), phosalone(O,O-diethyl-3-dithiophosporyl-methyl-6-chlorobenzoxazolone), sevin(1-naphtyl N-methylcarbamate), carbofuran(dimethyl-dihydrobenzofuryl N-methylcarbamate), decamethrin(alpha-cyanophenoxybenzyldibromovinyl-dimethylcyclopropane-carboxylate), cypermethrin(phenoxybenzyl cis-transdimethyldichlorovinylcyclopropane-carboxylate), and fenvalerate(alpha-cyanophenoxybenzyl chlorphenyl-methylbutylbutyrate), for example.

The biocidal preservatives and colorants described herein can be applied by brushing, spraying, soaking, and similar treatments. Pressure treatment is preferably employed to treat wood used in the ground and in many above ground applications. Freshly milled timber and wood for millwork or joinery may be treated with preservatives by dipping and double vacuum treatments.

### EXAMPLE 1

A series of tests were conducted with sodium lignosulfonate and humic acid salt. The basic copper carbonate material used had a weight mean particle size (diameter) of about 0.2 microns, with little (e.g., less than 4% by weight) or no particles present with a size greater than about 1 micron. The basic copper carbonate, tebuconazole, and sodium lignosulfonate and humic acid salt were mixed and milled to insure a wood-injectable composition was obtained. The amount of each ingredient is presented below.

| Ingredient | % By Wt. |
|---|---|
| Basic Copper Carbonate (55.7% Cu) | 35.9066 |
| Tebuconazole suspension concentrate, (39% Tebuconazole) | 2.081 |
| Sodium lignosulfonate, Vanasperse CB (Dispersant/Colorant) | 6.0 |
| Humic acid salt, BorreGro HA-1, or HA-2 (colorant) | 3.0 |
| Corrosion Inhibitor, proprietary | 2.5 |
| Defoamer, proprietary | 0.2 |
| Tap Water | 50.3124 |

Milling of the composition was done in a CB Mills Dyno™ Mill (ECM Technology) using 0.3 mm yttrium stabilized zirconium oxide milling media. The Mill Charge (Volume of media) was 0.39 Liters, and the mill was run at 1900 RPM for 15 minutes. This milling process provides a substantially sub-micron particulate suspension that may be diluted and directly injected into wood using traditional wood preservation methodology.

### EXAMPLE 2

An alternate and preferable method of providing a system that sufficiently colors wood allows the coloring agents to be added to the commercially available micronized wood preservative prior to treating wood. Either sodium lignosulfonate, humic acid salt or a combination of the colorants may be added to the wood preservative dilution. Three example of a tank mix useful for treating wood with Sustain 20T® plus certain listed auxiliary additives follow:

| Ingredient | % By Wt. |
|---|---|
| Sustain 20T ® (20% Cu + 0.8116% Tebuconazole) | 1.2 |
| Sodium lignosulfonate, Vanasperse CB (Dispersant/Colorant) | 0.1 |
| Water, Tap | 98.7 |
| Sustain 20T ® (20% Cu + 0.8116% Tebuconazole) | 1.2 |
| Humic acid salt, BorreGro HA-1, or HA-2 (colorant) | 0.05 |
| Water, Tap | 98.75 |
| Sustain 20T ® (20% Cu + 0.8116% Tebuconazole) | 1.2 |
| Sodium lignosulfonate, Vanasperse CB (Dispersant/Colorant) | 0.1 |
| Humic acid salt, BorreGro HA-1 or HA-2 (colorant) | 0.05 |
| Water, Tap | 98.65 |

### EXAMPLE 3

Water repellents are well known in the art and may be referred to as stabilizers. The above formulations may also include a water repellent if so desired. The use of a water repellent will aid in maintaining the appearance of the colorants and the wood. Water repellents may contain polymers, waxes or a combination of products. Water repellents/stabilizers should be added in sufficient quantity to provide adequate protection of the wood from weathering effects: swelling, due to saturation of water (rainfall, dew, etc.), and shrinkage due to drying by the sun.

The following formula contained colorant and water repellent/stabilizer:

| Ingredient | % By Wt. |
|---|---|
| Sustain 20T ® (20% Cu + 0.8116% Tebuconazole) | 1.2 |
| Sodium lignosulfonate, Vanasperse CB (Dispersant/Colorant) | 0.1 |
| Humic acid salt, BorreGro HA-2 (colorant) | 0.05 |
| Water repellent, proprietary polymeric formula (30% Active) | 0.5 |
| Water, Tap | 98.15 |

A modified full cell pressure-treatment method was used to treat southern yellow pine, which is similar to commercial practice and well known in the art. Any pressure treatment process known in the art is useful for this invention, however. The treatment cycle follows:

1. Initial vacuum—15″ Hg, no hold time

2. Immediately flood the treatment vessel with the treatment slurry while maintaining vacuum of 15″ Hg.

3. Release vacuum completely over 3-5 minutes.

4. Pressurize the treatment cylinder from 0 psi to 150 psi and releasing to 0 psi over a 15 minute period, generally maintaining 150 psi for 5-7 minutes.

5. Remove wood from the treatment slurry and replace the wood in the treatment vessel.

6. Final vacuum—26″, hold for 30 minutes and release vacuum over a 3-5 minute period.

7. Remove wood from treating vessel.

The formulations in each of the Examples described above were all prepared and injected into wood as described. The selected colorants provide significant color (light to medium brown depending on the concentration of colorant) to the treated wood.

The work showed that the wood preservative Sustain 20T® may be prepared within the presence of the selected coloring agents. The standard treating process allows uniform penetration of the formulations described above whether they were prepared by milling all of the ingredients together or by adding the colorants to the prepared preservative (Sustain 20T®).

Water repellents may be used with any of the colorant systems described herein. Other dyes, pigments, UV inhibitors, and the like may be used with any of the colorant systems described herein.

What is claimed:

1. A method for imparting brown and natural colorants to wood treated with micronized wood treatments, comprising: injecting into wood a slurry comprising a biocidally effective amount of micronized biocidal particles and also comprising a salt of lignosulfonate and a salt of humic acid in a total amount that is greater that 0.02 pounds total per cubic foot of wood, the quantity of salts of lignosulfonates and salts of humic acids being sufficient to impart a brown or dark tinge to the treated wood.

2. The method of claim 1 wherein the micronized biocidal particles comprise a crystalline sparingly soluble copper salt, a copper oxide, or both.

3. The method of claim 2 wherein the sparingly soluble copper salt is selected from copper borate, copper hydroxide, tribasic copper sulfate, basic copper carbonate, or mixture thereof.

4. The method of claim 2 wherein the sparingly soluble copper salt is selected from copper hydroxide, basic copper carbonate, or mixture thereof.

5. The method of claim 1 wherein the lignosulfonates and salts of humic acids are present in a total amount that is greater that 0.04 pound per cubic foot of wood.

6. The method of claim 1 wherein the lignosulfonates and salts of humic acids are present in a total amount that is greater that 0.08 pound per cubic foot of wood.

7. The method of claim 2 wherein the slurry comprises sufficient micronized biocidal particles to provide between 0.05 to about 0.3 pounds (as Cu) of sparingly soluble copper salts, copper oxide, or both per cubic foot of wood, and salts of lignosulfonate are present in the slurry in an amount to provide between 0.1 and 1 parts by weight of the one or more salts of lignosulfonate per one part of copper.

8. The method of claim 2 wherein the slurry comprises sufficient micronized biocidal particles to provide between 0.05 to about 0.3 pounds (as Cu) of sparingly soluble copper salts, copper oxide, or both per cubic foot of wood, and salts of lignosulfonate are present in the slurry in an amount to provide between 0.3 and 0.6 parts by weight of the one or more salts of lignosulfonate per one part of copper.

9. The method of claim 2 wherein the slurry comprises sufficient micronized biocidal particles to provide between 0.05 to about 0.3 pounds (as Cu) of sparingly soluble copper salts, copper oxide, or both per cubic foot of wood, and between 0.05 and 1 parts by weight of one or more salts of humic acid per one part of copper.

10. The method of claim 2 wherein the slurry comprises sufficient micronized biocidal particles to provide between 0.05 to about 0.3 pounds (as Cu) of sparingly soluble copper salts, copper oxide, or both per cubic foot of wood, and between 0.1 and 0.3 parts by weight of one or more salts of humic acid per one part of copper.

11. The method of claim 1, the slurry further comprising a water repellent.

12. A method of coloring wood treated with a biocidally effective amount of micronized biocidal particles comprising injecting into the wood a liquid comprising a salt of lignosulfonate and salts of humic acids in a total amount that is greater that 0.02 pound per cubic foot of wood, the quantity of lignosulfonates and salts of humic acids being sufficient to impart a brown or dark color to the treated wood.

13. The method of claim 12 wherein the micronized biocidal particles comprise a crystalline sparingly soluble copper salt, a copper oxide, or both.

14. The method of claim 13 wherein the sparingly soluble copper salt is selected from copper borate, copper hydroxide, tribasic copper sulfate, basic copper carbonate, or mixture thereof.

15. The method of claim 13 wherein the sparingly soluble copper salts is selected from copper hydroxide, basic copper carbonate, or mixture thereof.

16. The method of claim 12 wherein the lignosulfonates and salts of humic acids are present in a total amount that is greater that 0.04 pound per cubic foot of wood.

17. The method of claim 12 wherein the lignosulfonates and salts of humic acids are present in a total amount that is greater that 0.08 pound per cubic foot of wood.

18. The method of claim 13 wherein the micronized biocidal particles provide between 0.05 to about 0.3 pounds (as Cu) of sparingly soluble copper salts, copper oxide, or both per cubic foot of wood, and salts of lignosulfonate are present in the liquid in an amount to provide between 0.1 and 1 parts by weight of the one or more salts of lignosulfonate per one part of copper.

19. The method of claim 13 wherein the micronized biocidal particles provide between 0.05 to about 0.3 pounds (as Cu) of sparingly soluble copper salts, copper oxide, or both per cubic foot of wood, and the salts of humic acid are present in the liquid in an amount sufficient to provide between 0.05 and 1 parts by weight of one or more salts of humic acid per one part of copper.

20. The method of claim 12, the slurry further comprising a water repellent.
